(19) United States
(12) Patent Application Publication
(10) Pub. No.: US 2007/0023427 A1
(43) Pub. Date: Feb. 1, 2007

(54) New construction box protector/locator

(76) Inventor: Ann Brennan, Corona, CA (US)

Correspondence Address: JOSEPH R. CRUSE, JR, SUITE 1760, 301 E. OCEAN BLVD., LONG BEACH, CA, 90802, US

(21) Appl. No.: 11/191,508

(22) Filed: Jul. 28, 2005

(51) Int. Cl. H02G 3/08

(52) U.S. Cl. 220/3.8

(57) ABSTRACT

A temporary protective cover for electrical outlet boxes and plumbing outlet boxes which prevents the outlet boxes from being damaged and prevents debris and/or tools from entering the outlet boxes during the drywall, stucco, siding and all finishing material installation phases during new construction. The cover is molded in one piece and is constructed of a non-conducting material provided with a base member that is universally dimensioned to cover the openings of all conventionally sized electrical and plumbing type outlet boxes. The cover contains a retaining member that is universally dimensioned to fit inside the openings of all conventionally sized electrical and plumbing type outlet boxes. On the opposing side of the retaining member, a rigid extending member is universally dimensioned to cover the outlet boxes, so that when drywall, stucco, siding and all other like finishing materials are installed, it permits uncomplicated discovery of the cover and outlet boxes underneath without damage. The rigid extending member may be constructed so as to contain a durable handle which can be recessed or protruding for easy removal with pliers and/or with construction cut-out tools. Additionally, the rigid extending member and/or durable handle may contain a metallic material to further aid detection. The cover may be reusable or disposable.

### BACKGROUND OF THE INVENTION

1. Field of the Invention

This invention relates to the protection and location of electrical and plumbing outlet boxes during the finishing phase of new construction, and more specifically pertains to the protection of outlet boxes and the wires contained inside by preventing drywall, stucco and all other like finishing material from entering, and further providing an indicating member which assists in locating the outlet box which is covered beneath the drywall, stucco and all like finishing material in the finishing phase of new construction preventing further damage to the drywall, stucco and all like finishing material to be installed.

2. Background of the Invention

During new home construction, plumbing and electrical outlet boxes are commonly installed prior to the installation of drywall, stucco and all like finishing materials. The electrical outlet boxes are commonly attached to the framework, which the drywall is attached to.

Also prior to the drywall installation and/or a stucco/finishing phase, the electrical wiring is installed, wherein the electrical wiring is passed throughout the house terminating at the electrical outlet boxes. This is performed in this sequence due to the ease of installing the wiring and plumbing prior to covering them up along with the framing with drywall and stucco/finishing material.

After the framing, plumbing and electrical outlet boxes are installed, the drywall is installed in full sheets, rather than having the holes for access to the outlets already precut.

Once the drywall is installed, the next step is to discover the locations of all of the outlet boxes that need to be uncovered. In order to discover the outlet boxes, it is common for a drywall finisher to tap his drywall knife or like tool along the drywall to discover the outlets. This is extremely inaccurate since many outlet boxes are attached to the framing underneath and makes it difficult for the finisher to discover.

Another common way to discover the outlet boxes hidden behind the drywall is for the drywall finisher to run his hand along the drywall and feel a difference in the drywall indicating the placement of an outlet box. This is also very difficult to do since the outlet boxes are often flush with the framing and when set out slightly it only leaves a slight bulge with no indication of where the actual outlet box walls are located.

Once the drywall finisher can hopefully discover the outlet box, he will cut the drywall with his drywall knife or other sharp object Often the estimate is inaccurate and the cut drywall must be repaired, necessitating additional time and expense. This method is also extremely dangerous even if the finisher is accurate since placing any type of sharp object into the drywall may cut or split an electrical wire hidden behind the drywall, even if it is safely inside the outlet box.

As set forth above, this situation of discovering the outlet boxes is both dangerous and common. The danger of an electrical sparking and/or short is even more difficult to discover if the wire is cut outside the outlet box since the drywall will be covering it up. Only once the power is activated inside the house, will a short be discovered. These numerous mistakes in attempting to discover the outlet boxes lead to costly repairs, which only lead to increased costs in construction and inferior quality.

### OBJECTS AND ADVANTAGES

Accordingly, besides the objects and advantages of the new construction box protectors/locators described herein, several objects and advantages of the present invention are:
(a) to provide a new construction box protector/locator that will protect the outlet box, and its interior, by permitting placement of the cover over the outlet box prior to drywall and stucco/finishing material installation;
(b) to provide a new construction outlet box protector/locator that will protect the outlet box, and its interior, from a worker damaging the outlet box by cutting an imprecise hole into the drywall and/or stucco/finishing material to expose the outlet box for its intended use;
(c) to provide a new construction outlet box protector/locator that will protect the outlet box, and its interior, from debris that commonly would make its way inside the outlet box during the drywall and stucco/finishing material phase that routinely occurs.
(d) to provide a new construction box protector/locator that will enable the worker to easily discover the location of the outlet boxes, by providing a rigid extending member with a metallic material located on it for easy identification with a metal stud finder or like tool, while also continuing to protect the outlet box;
(e) to provide a new construction box protector/locator that will enable the worker to easily discover the location of the outlet boxes, by providing a rigid extending member to extend beyond all other finishing material such as stucco for easy identification, while also continuing to protect the outlet box and keeping all finishing material such as stucco, and paint out of the outlet box;
(f) to provide a new construction box protector/locator that can be installed over an outlet box with or without screws;
(g) to provide a new construction box protector/locator that will work with all of the commonly dimensioned outlet boxes for use in both the plumbing and electrical industries; and
(h) to provide a new construction box protector/locator that is light, inexpensive, uncomplicated, durable and easy to use.

Further objects and advantages are to provide for an ease of removal of the new construction box protector by constructing the rigid extending member of a durable material so that a worker can pull the construction box protector off of the cover with a common pair of pliers and/or cut-out tools.

Still further objects and advantages will become apparent from a consideration of the ensuing description and drawing.

### SUMMARY

In accordance with the present invention a new construction box protector/locator comprises a cover containing a retaining member and a rigid extending member placed on the opposing side.

### DRAWINGS—FIGURES

In the drawings, closely related figures have the same number but different alphabetic suffixes.

FIG. 1 shows a side view of a New Construction Box Protector/Locator equipped with a Rigid Retaining Member, Rigid Extending Member and Protruding Durable Handle.

FIG. 2 shows a side view of the New Construction Box Protector/Locator equipped with a Rigid Retaining Member, a Rigid Extending Member and a recessed Durable Handle.

FIG. 3 shows a top view of the New Construction Box Protector/Locator equipped with a Rigid Retaining Member, a Rigid Extending Member and a protruding Durable Handle.

FIG. 4 shows a top view of the New Construction Box Protector/Locator equipped with a Rigid Retaining Member, a Rigid Extending Member and a recessed Durable Handle.

FIG. 5 shows a diagonal view of the New Construction Box Protector/Locator with the Rigid Retaining Member, Rigid Extending Member and Attachment Holes

### REFERENCE NUMERALS

12 Rigid Extending Member

13 Rigid Retaining Member

14 Durable Handle

15 Metallic Locator

16 Attachment Holes

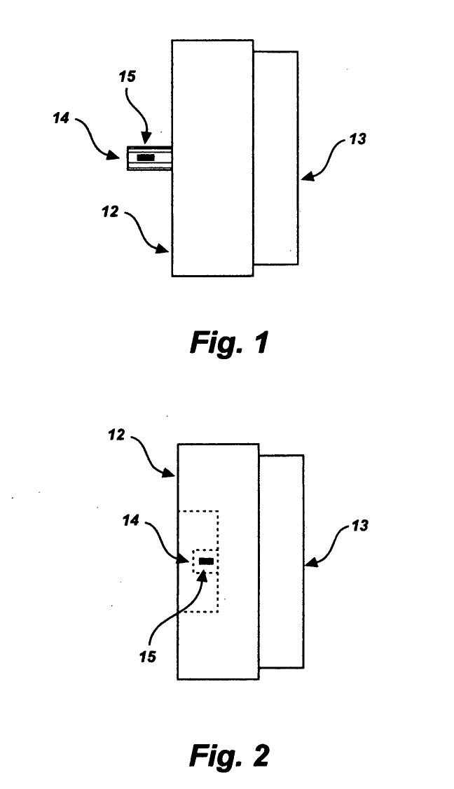

### DETAILED DESCRIPTION—FIGS. 1(a), 1(b), 2(a), 2(b),AND 3—PREFERRED EMBODIMENT

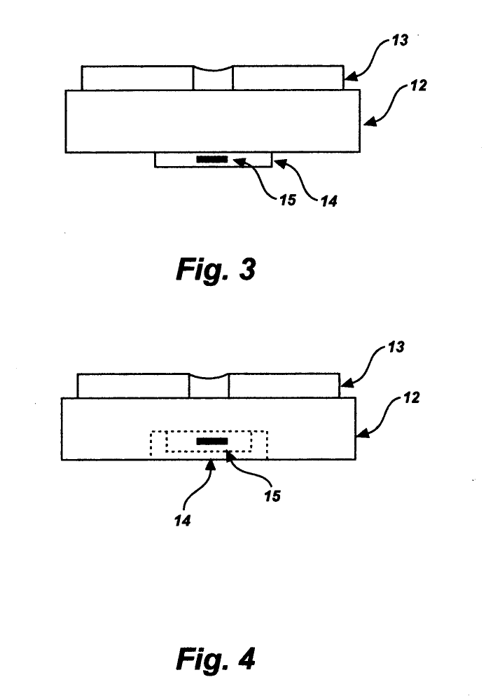

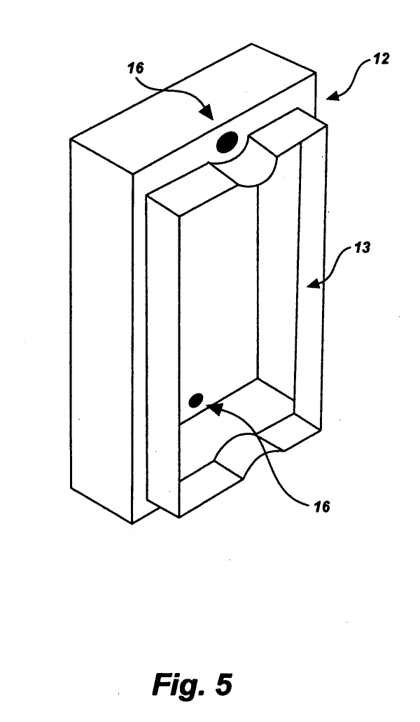

A preferred embodiment of the apparatus of the present invention is illustrated in FIGS. 1 and 2 (side view), FIGS. 3 and 4 (top view) and FIG. 5 (diagonal view). The apparatus has a rigid extending member (12) consisting of a rigid material that is non-conducting. The extending member (12) has a bottom side where a Rigid Retaining Member is attached (13).

On the opposite end of the extending member (12), is attached a Durable Handle (14), In the preferred embodiment, the Extending Member (12), Retaining Member (13), and Durable Handle (14) are a one piece mold made out of a rigid non-electrical conducting material.

The Extending Member (12) possesses two Attachment Holes (16), so that screws or nails may be passed through to secure the cover (12) onto the outlet box.

The Attachment Holes (16) may further be used to attach to a cut-out tool to assist in removal.

The Durable Handle (14) and/or the Rigid Extending Member (12) may contain a metallic locator (15).

The Durable Handle (14) may be recessed in the Rigid Extending Member (12). FIGS. 2 and 4 or may protrude from the Rigid Extending Member (12), FIGS. 1 and 3.

I claim:

1. A removable protective cover and locater for electrical and plumbing outlet boxes, wherein said protective cover comprising a rigid extending member, a rigid retaining member for engaging said boxes to retain said cover as a closure of the box in order to prevent entry of debris and tools into the box during construction, and said extending member including a handle projecting outward on the opposite side of the retaining member, whereupon the handle serves as a removal locater means.

2. A removable protective cover and locater for electrical and plumbing outlet boxes as defined in claim 1, wherein said cover is entirely made of a electrically non-conductive material.

3. A removable protective cover and locater for electrical and plumbing outlet boxes as defined in claim 1, wherein said cover is disposable.

4. A removable protective cover and locater for electrical and plumbing outlet boxes as defined in claim 1, wherein said cover is reusable.

5. A removable protective cover and locater for electrical and plumbing outlet boxes as defined in claim 1, wherein said extending member possesses two holes to thread screws through to attach said cover to said box.

6. A removable protective cover and locater for electrical and plumbing outlet boxes as defined in claim 1, wherein said extending member possesses two holes to assist with the use of cut-out tools for removal.

7. A removable protective cover and locater for electrical and plumbing outlet boxes as defined in claim 1, wherein said handle is made of a durable material.

8. A removable protective cover and locator for electrical and plumbing outlet boxes as defined in claim 1, wherein said handle is recessed within the extending member.

9. The durable handle as defined in claim 7, wherein said handle contains a metallic material.
